(19) United States
(12) Patent Application Publication
(10) Pub. No.: US 2003/0152723 A1
(43) Pub. Date: Aug. 14, 2003

(54) Moisture sorbing device for screens comprising organic light emitting diodes and process for the manufacture thereof

(75) Inventors: Luciano Pisoni, Marcallo Con Casone (IT); Massimo della Porta, Milano MI (IT)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: SAES GETTERS S.p.A.

(21) Appl. No.: 10/385,724

(22) Filed: Mar. 10, 2003

Related U.S. Application Data
(63) Continuation of application No. PCT/IT01/00489, filed on Sep. 25, 2001.

(30) Foreign Application Priority Data
Sep. 27, 2000 (IT) MI2000A 002098

(51) Int. Cl. B32B 1/02

(52) U.S. Cl. 428/34.1; 428/137; 428/690

(57) ABSTRACT

A moisture sorbing device (20, 20′) to be used in the screens of the type with organic light emitting diodes (30) is described. Further, a process for manufacturing moisture sorbing devices according to the invention is described.

The present invention relates to a moisture sorbing device for screens comprising organic light emitting diodes and to a process for the manufacture thereof.

Organic light emitting diodes have been studied in recent years for the production of flat screens, having very low thickness and weight. The main applications foreseen in the next future are as light screens for mobile phones, stereophonic sets, for car dashboards and similar, but the manufacture of screens having a large size capable of showing moving images, to be used for instance as computer or television screens, is not excluded.

Organic light emitting diodes are punctiform light sources better known in the specialized literature with the acronym OLED. With the same acronym are also indicated the screens which are formed of a multiplicity of such diodes; in the rest of the text, by OLED it will be meant a screen, unless differently stated.

In brief, the structure of an OLED is formed of a first transparent support, essentially planar, generally made of glass or of a plastic polymer; a first series of transparent electrodes, linear and parallel to each other, deposited on the first support; a double layer of different organic electro-luminescent materials, of which the first is a conductor of electrons and the second of electron vacancies, deposited on the first series of electrodes; a second series of electrodes, linear and parallel to each other and orthogonal to those of the first series, which are in contact with the upper portion of the double layer of organic materials, so that this is comprised between the two series of electrodes; and a second support, not necessarily transparent, which can be made in glass, metal or plastic, essentially planar and parallel to the first support. The two supports are fastened to each other along their perimeter, generally by gluing, so that the active portion of the structure (electrodes, electro-luminescent organic materials) is in a closed space. The first transparent support is the part where the image is visualized, whereas the second support has generally only the function of sealing and backing of the device, in order to confer thereto a sufficient mechanical strength.

The material forming the first series of transparent electrodes is commonly the ITO, a mixture of tin and indium oxides, but also other mixtures of oxides can be employed, generally based on tin and zinc oxides, conductive polymers such as the polyimides or extremely thin layers (hundreds of Angstrom) of metals having a high electric conductivity, such as Al, Cu or Au.

The material of the second series of electrodes can be one of those above mentioned for the first series or, in case of non-transparent electrodes, a metal or an alloy. The most commonly used materials are the alloys Al—Li or Al—Mg or composite double layers formed of aluminum on which thin layers of alkaline or alkaline-earth metals or compounds thereof are deposited; examples of such composite double layers are Al—LiF or Al—Li₂O.

The electro-luminescent organic materials can be in the form of discrete molecules or polymeric, but in any case they are polyunsaturated species; the most commonly used compound is a complex of aluminum with quinoline.

For an exposition of the working principles of the OLEDs and greater details on the structure thereof, the literature of the field is referred to.

The main problem which has been found with these devices is that they rapidly lose their light emission features upon moisture sorption. The life of these devices is reduced from thousands or tens of thousands of hours in the absence of moisture, as experimentally verified in suitable chambers, to a few hours when exposed to the atmosphere. Even if the mechanisms of functional degradation of the OLEDs have not been completely explained yet, it is likely that the phenomenon can be ascribed partly to reactions of addition of the water molecule to the unsaturated bonds of the organic component, and on the other side to the reaction of water with the electrodes, particularly the metal cathodes. The main entrance of the water into the OLEDs is the perimetrical seal of the two supports, which is generally carried out by gluing by means of epoxy resins permeable to water, used by nearly all the manufacturers. Moisture can also be released by the same internal components of the OLED.

U.S. Pat. Nos. 5,804,917 and 5,882,761 and the publications of international applications WO 98/59356 and WO 99/35681 describe the use of moisture sorbing materials inside the devices. However, all these documents indicate the use of the sorbing material in a generical way, but they do not explain how it is possible to integrate the step of introducing the material in the OLED during the manufacturing process of the device. Further, it is necessary to prevent the sorbing material from coming into contact with the electrodes or the layers of organic materials, in order to avoid that these are damaged by compression or friction; the cited documents do not provide useful information regarding how to avoid that during the OLED life the material undergoes deformations or particle loss upon water sorption.

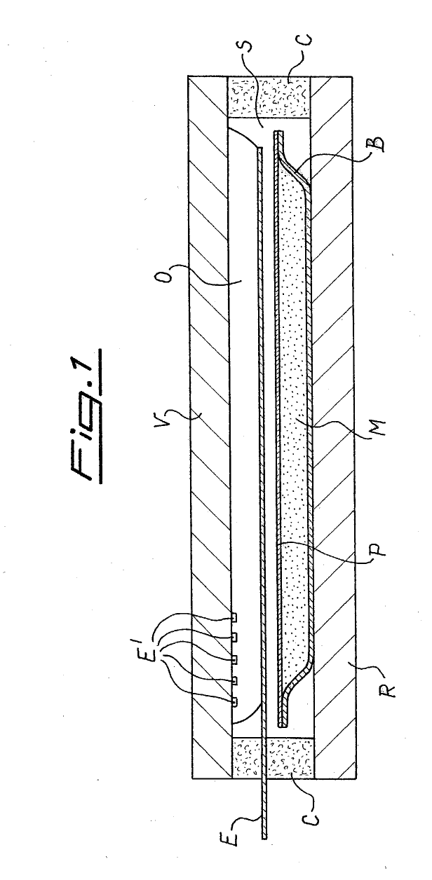

An improvement with respect to the systems of the cited documents is represented by research publication RD 430061. This document describes a moisture sorbing device to be inserted into the OLED, generally formed of a rectangular aluminum-polyethylene bilayer sheet with a central recess wherein a moisture sorbing powder material is arranged (for instance, CaO); a sheet of a polymeric material, permeable to water but capable to retain the powder particles of the sorber, is heat-sealed along the edges of the aluminum sheet. The best material was found to be a polyethylene nonwoven fabric. The assembly is a discrete object which can be arranged into the internal space of the OLED. FIG. 1 shows in cross-section and in a very schematical way the structure of an OLED wherein a moisture sorbing device of the type described in document RD 430061 is inserted: the OLED is formed of a front face V, generally made of glass, and of a back support R, made of glass or metal, which are glued along their perimeter with a glue C so as to define an internal space S. Inside space S is provided, on the side of glass V, the active structure, formed of two mutually orthogonal series of electrodes, E and E′, between which the layers of electro-luminescent organic materials, O, are comprised. In the opposite portion of space S, against support R, is inserted the moisture sorbing device, formed of a bilayer B of aluminum (in the portion contacting R) and a plastic material (facing the inside of space S), of a water-permeable polymeric membrane P and of a moisture sorbing material, M.

However, this system too presents some problems. First, for productivity reasons the moisture sorbing devices are obviously not produced one at a time, but in continuous processes, starting from bands of permeable polymer and of the aluminum-plastic bilayer, or in discontinuous processes, by using permeable polymer and bilayer sheets of large size, and making from these several sorbing devices at a time. In both cases, the single sorbing devices are separated from the band or sheet by cutting. In this operation, burrs in the aluminum sheet are generally formed, which may come up in the upper portion of the sheet of permeable polymer and touch the electrodes causing them to short-circuit, thus altering the correct functioning of the OLED.

Other problems are due to the requests of miniaturization of the OLEDs manufacturers. The thickness of space S is always lower than one millimeter, and sorbing devices whose thickness is not higher than 0.4 mm are presently requested. As determined with practical tests, the thickness of the water permeable polymeric layer cannot be lower than about 0.1 mm, lest an excessive reduction of mechanical strength and possible loss of particles of the sorbing material. Also the thickness of the aluminum-polyethylene bilayer cannot be reduced under about 0.065 mm. The reason is that with lower thickness values the sheet has a poor mechanical consistency, and the tensions induced therein by the pressing necessary to form the central recess cause deformations from the planarity which make practically impossible the subsequent filling step with the sorbing material. Further, in these conditions also the whole sorbing device can be deformed with respect to the ideal planar shape, either immediately after the manufacture or following to the steps of introduction into the OLED, thus occupying a greater thickness than the theoretical one and touching the active portions of the device, with the above mentioned risks of ruining by rubbing or pressing the electrodes or the organic layers. These lowest possible thickness values for components P and B limit the space available for the material M, and therefore the total moisture sorbing capacity of the device.

Object of the present invention is providing a moisture sorbing device for screens comprising organic light emitting diodes which does not have the drawbacks of the prior art, as well as to provide a process for manufacturing this device.

These objects are obtained according to the present invention which in a first aspect thereof relates to a device formed of:

a membrane which is permeable to water but capable of retaining solid particles, having a perimetrical edge raised with respect to the central portion thereof,

a sheet of a material impermeable to fluids fastened to the membrane along all said perimetrical edge, which together with the membrane defines a closed space at the central portion of the membrane itself;

a moisture sorbing material having a water equilibrium pressure lower than 10⁻² mbars between −15° C. and 130° C. in said closed space.

The invention will be now described with reference to the figures, wherein:

FIG. 1 shows in cross-section and in a schematical form an OLED comprising a moisture sorbing device according to the prior art;

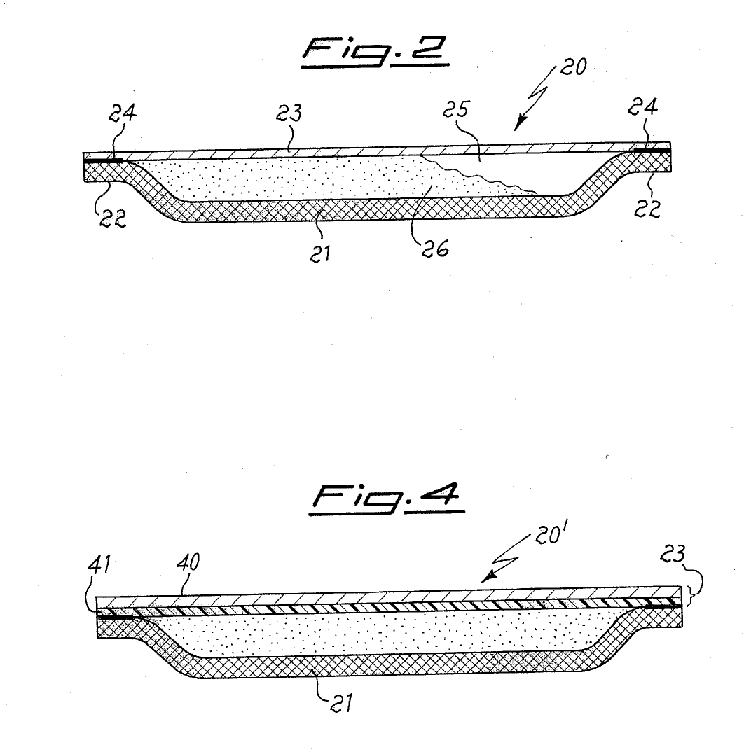

FIG. 2 shows in cross-section in a schematical form one embodiment of the moisture sorbing device of the invention;

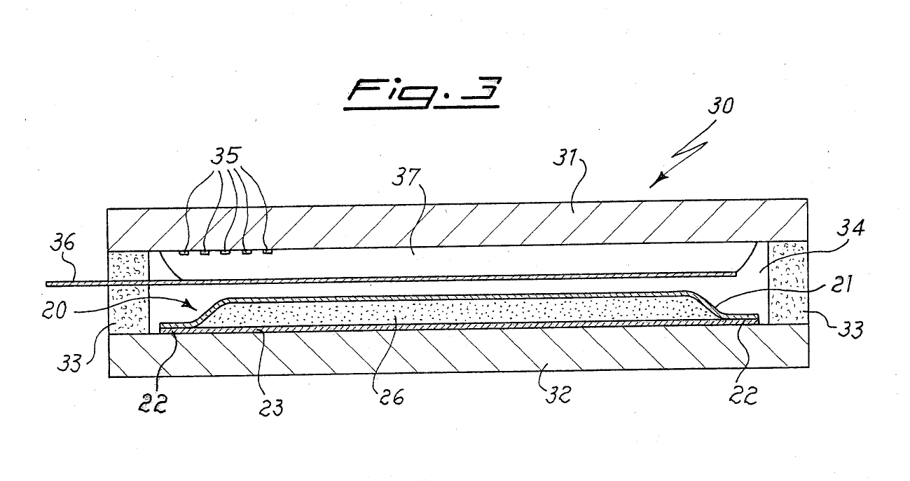

FIG. 3 shows in cross-section an OLED comprising a moisture sorbing device according to the invention;

FIG. 4 shows in cross-section an alternative embodiment of the moisture sorbing device of the invention;

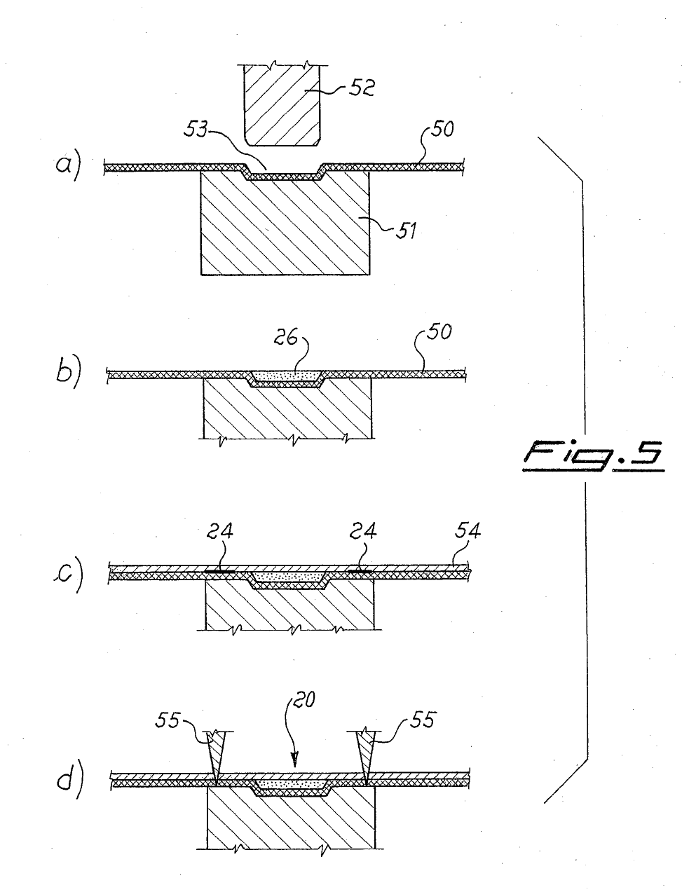

FIG. 5 shows the main steps of the process for manufacturing the device according to the invention.

For the sake of clarity of the drawings, the members shown in the figures are not in scale, and particularly the thickness values are notably increased with respect to the lateral size.

FIG. 1 has been already described with reference to the discussion of the prior art.

FIG. 2 shows in cross-section a first possible moisture sorbing device according to the invention. Device 20 is formed of a membrane 21 with a perimetrical edge 22 raised with respect to the central portion thereof. A sheet 23 impermeable to fluids is fixed to membrane 21, along the whole edge 22. The fixing is made along the perimetrical area 24 by gluing o heat-sealing according to the type of sheet 23 used, as it will be described in the following. A space 25, filled with the moisture sorbing material 26 is defined between the central portion of the membrane and sheet 23; the drawing shows a partial filling in order to mark space 25, but in the real devices this is obviously filled completely with material 26.

FIG. 3 shows, in a cross-sectional view and in an extremely schematical form, the main elements which form an OLED comprising a moisture sorbing device according to the invention. Screen 30 is formed of a first transparent support 31 and of a second support 32, joined along the whole perimeter thereof with a sealing material 33, generally an epoxy resin. The two supports 31 and 32 define an internal space 34, wherein it is necessary to prevent the presence of moisture. The structure formed of the two mutually orthogonal series of electrodes, schematized as elements 35 and 36, between which the electro-luminescent organic material 37 is inserted, is provided on support 31. In space 34, contacting support 32 (in an upside down orientation with respect to that shown in FIG. 2), is provided the moisture sorbing device 20 formed of the water permeable membrane 21, of the impermeable sheet 23 and of the moisture sorbing material 26.

Membrane 21 has the function of confining material 26 in an area of space 34, at the same time allowing moisture which is present inside said space to easily and quickly get in contact with material 26. To this purpose, membrane 21 preferably has a water conductivity higher than 0.1 mg/(hour×cm ²). Further, the membrane must have a sufficient mechanical consistency, such that it can be formed by pressing. Said membrane can be of the type having homogeneous size and distribution of the holes; a similar membrane can be formed of a metal net, of a polymeric fabric or a microperforated metallic or polymeric sheet. Among these, for reasons of cost and lightness, the use of membranes of polymeric material is preferred. These membranes must have openings not larger than 20 (m, in order to retain the powders of the sorbing material 26. Alternatively, it is possible to use membranes with uneven distribution and size of the pores, such as the sheets of aluminum having thickness of 4 or 5 (m produced by the Japanese company Toyo, which are provided with microperforations having random distribution, or preferably nonwoven fabric membranes. Typical nonwoven fabric membranes are those made of polyethylene, for example high density polyethylene (known in the filed as HDPE); membranes of this type are commercially available under the name Tyvek® (registered trademark of the company DuPont de Nemours). It has been empirically demonstrated that a membrane of nonwoven fabric of HDPE having a thickness of at least 0.12 mm has all the features requested by the invention, i.e., it is sufficiently rigid so that it can be formed by pressing, it has the requested values of water permeation velocity and a device of the invention made with this membrane does not lose particles of the solid material 26. The thickness of a membrane of nonwoven fabric suitable for the purposes of the invention is preferably not higher than 0.15 mm. Membranes having higher thickness values would obviously meet the requirement of mechanical strength, but they would uselessly reduce the thickness available for the moisture sorbing material 26.

Sheet 23 is made of a material impermeable to fluids. The reason is that device 20 is preferably inserted into screen 30 by sticking sheet 23 to support 32; this ensures that device 20 does not contact the active portion of the OLED, formed of the assembly of elements 35, 36 and 37. A sheet 23 permeable to fluids could enable the passage of the glue towards space 25 and therefore material 26, thus incorporating at least partially the latter and reducing the exposed surface thereof and therefore the moisture sorbing capacity.

The preferred materials for making sheet 23 are metals or the multilayers made of at least one metal-plastic double layer. Among metals, the use of aluminum is preferred, because of the easiness to obtain sheets of low thickness, of the lightness and the low cost. In case sheet 23 is made of aluminum, the fastening between this and membrane 21 along area 24 is made with glues, for example epoxy resins. In the preferred embodiment thereof, schematized in FIG. 4, device 20′ is manufactured by using for sheet 23 a multilayer formed of at least one metal layer 40 and one in plastic material 41. In this case sheet 23 is fixed to membrane 21 preferably by heat-sealing, layer 41 facing membrane 21. The preferred metal material for layer 40 is still aluminum, for the above considered reasons. The plastic material for layer 41 is a material that can be thermally sealed to the material of membrane 21. Preferred for this purpose is the use of a material chemically similar to that of membrane 21, for instance a low density polyethylene (known in the field as LDPE). Two layers sheets of this type are widely known in the packaging field, for example of foods, and they can be manufactured for example by hot rolling, passing through compression rollers one metal sheet and one in plastic material, both hot; or by cold rolling, by interposing a layer of glue between a metal sheet and a plastic sheet and passing the two sheets between two compression rollers. For the purposes of the invention, it is also possible to use multilayers wherein the metal layer is obtained by evaporation of the metal on a plastic sheet. It is also possible to use more complex multilayers (not shown in the figures), for instance plastic-metal-plastic trilayers, wherein the plastic layer which is not in contact with membrane 21 can be made with the most various materials: for example, the third layer may be made in nylon, in order to increase the sliding of sheet 23 when it is moved by the automatic manufacturing machines. The use of the simple double layer can however be preferred for the lowest thickness values which can be obtained, which allow to maximize the room available for the sorbing material 26.

Material 26 can be any material capable of sorbing moisture and having an equilibrium water pressure lower than 10⁻² mbars in the whole range of temperatures of use foreseen for the OLEDs, between about −15° C. and 130° C. Among these materials, preferred are the alkali-earth metals oxides, such as CaO, SrO and BaO; particularly preferred is CaO because it does not pose safety or environmental problems during the OLED manufacturing steps or disposal, and further because of its low cost. Material 26 is preferably in the form of a powder, having a particle size generally comprised between 1 and 300 μm, and preferably comprised between 10 and 100 μm. Material 26 can be additioned with powder of other materials, for example small quantities of inert materials such as alumina, with the purpose of preventing an excessive packing of material 26 upon water sorption, or of materials sorbing other gases, such as oxygen, hydrogen or carbon oxides.

In a second aspect thereof, the invention relates to a process for manufacturing a moisture sorbing system, which generally comprises the steps of:

providing a sheet of a water permeable membrane, capable of retaining powders and having a mechanical consistency sufficient for being formed by pressing;

forming by pressing at least one recess in said membrane sheet;

filling said recess with powder of a moisture sorbing material;

fixing to the membrane sheet along a continuous perimetrical area around the recess a sheet of a material impermeable to fluids.

The devices are produced with an upside down orientation with respect to that shown in FIGS. 2 and 4. The process is schematically shown in FIG. 5. In the first step, a), a sheet 50 is placed between a mould 51 and a punch 52, thus forming in the sheet a recess 53. In the following step, b), recess 53 is scrape filled with powder 26 of the moisture sorbing material (or of a suitable mixture thereof with other materials, as previously described). Scrape filling consists in introducing a suitable quantity of the powder material into recess 53, and removing a possible exceeding portion by “scraping” the surface of sheet 50 with a suitable blade. In step c), an impermeable sheet 54 is placed onto sheet 50 and the two sheets are fixed to each other along a continuous area 24 around recess 53, by gluing or heat-sealing as described.

The process described up to now relates to the production of one sorbing device at a time, but obviously for reasons of productivity and economicity, the process is preferably carried out continuously, by using both the sheet which forms the membrane and the impermeable sheet in the form of tapes which are continuously fed to the stations for forming the recesses, filling with the sorbing material and closure with the impermeable sheet; alternatively, sheets of large size can be used, and the above mentioned steps are carried out in different points of the sheet at the same time, thus simultaneously producing more devices. In both cases several sorbing devices are obtained from each couple of sheets, and the single devices 20 (or 20′) are therefore produced by means of a further step, d), wherein these are separated from sheets 50 and 54, for example by mechanical cut with the tools schematized in the drawing as elements 55. In the case that the fastening between sheets 50 and 54 id made by heat-sealing, steps c) and d) can also be carried out at the same time.

As shown in FIG. 3, contrary to the device disclosed in document RD 430061, device 20 (or 20′) according to the invention is made in such a way that the volume for receiving the sorbing material is obtained in permeable membrane 21. In this way, when device 20 (or 20′) is introduced in space 34, since the membrane always faces the active part of the OLED (elements 35, 36 and 37), perimetrical edge 22 is in contact with support 32, in the farthest position from said active portion. This avoids the above mentioned prior art problems, that is, the possibility that the folded portions of the perimetrical edge 22 or the metal burrs thereon get in contact with said active portion of the OLED thus damaging it or short circuiting two or more electrodes.

1. Moisture sorbing device (20; 20′) for screens of the organic light emitting diode type, consisting of:
a membrane which is permeable to water (21) but capable of retaining solid particles, having a perimetrical edge (22) raised with respect to the central portion thereof;
a sheet of a material impermeable to fluids (23) fixed to the membrane along all said perimetrical edge, and that together with the membrane defines a closed space (25) at said central portion of the membrane itself;
a moisture sorbing material (26) having an equilibrium water pressure lower than 10⁻² mbars between −15° C. and 130° C. in said closed space.

2. A device according to claim 1 wherein the membrane has water conductivity higher than 0.1 mg/(hour×cm²).

3. Device according to claim 1 wherein the membrane is formed of a material selected among metal nets, polymeric fabrics, microperforated metallic or polymeric sheets having an even distribution and size of the microperforations.

4. A device according to claim 3 wherein said microperforations have a size not higher than 20 μm.

5. A device according to claim 1 wherein the membrane is formed of a material having an uneven distribution and size of pores.

6. A device according to claim 5 wherein said membrane is made of an aluminum sheet having a thickness lower than 5 μm.

7. A device according to claim 5 wherein the membrane is made of a high-density polyethylene nonwoven fabric whose thickness is equal to or higher than 0.12 mm.

8. A device according to claim 7 wherein the membrane has a thickness of about 0.15 mm.

9. A device according to claim 1 wherein the sheet of material impermeable to fluids is made of metal.

10. A device according to claim 9 wherein the metal is aluminum.

11. A device according to claim 1 wherein the sheet of material impermeable to fluids is made of a multilayer made of at least one metal layer (40) and one of plastic material (41).

12. A device according to claim 11 wherein the sheet of material impermeable to fluids is made with an aluminum layer and a layer of low-density polyethylene.

13. A device according to claim 1 wherein the membrane and the sheet impermeable to fluids are fixed along the perimetrical edge by gluing.

14. A device according to claim 11 wherein the membrane is made of polymeric material and is heat-sealed along the perimetrical edge to the sheet of material impermeable to fluids.

15. A device according to claim 14 wherein the membrane is made of high-density polyethylene nonwoven fabric.

16. A device according to claim 1 wherein the moisture sorbing material is selected among CaO, SrO and BaO.

17. A device according to claim 16 wherein the moisture sorbing material in the form of a powder.

18. A device according to claim 17 wherein the moisture sorbing material has a particle size comprised between 1 and 300 μm.

19. A device according to claim 18 wherein the moisture sorbing material has a particle size comprised between 10 and 100 μm.

20. A device according to claim 1 containing, in addition to the moisture sorbing material, one or more among inert materials which impede the packing of the moisture sorbing material or other gas sorbing materials.

21. A process for the production of a moisture sorbing system, comprising the steps of:
providing a sheet of a membrane (50), permeable to water but capable of retaining powders and having a mechanical consistency sufficient for being formed by pressing;
forming by pressing between a mould (51) and a punch (52) at least one recess (53) in said membrane sheet;
filling said recess with powder of a moisture sorbing material (26);
fixing a sheet (54) of a material impermeable to fluids to said membrane sheet along a continuous perimetrical area around the recess.

22. A process according to claim 21, further comprising the step of separating at least one moisture sorbing device (20) from said membrane (50) and impermeable (54) sheets.

23. Screen (30) of the type with organic light emitting diodes formed of a first transparent support (31) and a second support (32) which are joined along their whole perimeter with a sealing material (33) so as to define an internal space (34); a structure in contact with the first support formed of two series of mutually orthogonal electrodes (35, 36) with an electro-luminescent organic material (37) interposed; and a moisture sorbing device (20; 20′) according to claim 1, in contact with said second support, in such a way that said perimetrical edge of said device is in contact with said second support.
